(19) United States
(12) Patent Application Publication
(10) Pub. No.: US 2023/0016212 A1
(43) Pub. Date: Jan. 19, 2023

(54) Mobile Device Charger

(71) Applicant: Daniel Jahmain Sinclair, Los Angeles, CA (US)

(72) Inventor: Daniel Jahmain Sinclair, Los Angeles, CA (US)

(21) Appl. No.: 17/664,872

(22) Filed: May 25, 2022

(51) Int. Cl. H02J 50/00; H02J 7/00; A45F 5/02

(52) U.S. Cl. CPC H02J 50/005; H02J 7/0044; A45F 5/021

(57) ABSTRACT

A mobile device holster which includes a wireless charging base and a rotatable belt clip with a retractable prong housing. When a mobile device is inserted into the mobile device holster, the wireless battery of the mobile device becomes aligned with the wireless charging base of the mobile device holster. By rotating the belt clip and sliding the prong housing forward, the mobile device holster can be converted into an elevated charging device when inserted into an AC wall socket.

### FIELD OF INVENTION

The present invention relates to the field of electronics.

### BACKGROUND OF THE INVENTION

Charging a mobile device with a charging cable is inconvenient. To charge a mobile device with a charging cable, the device user must first take the time to retrieve the charging cable and connect it to the device and wall socket. Once the device is charged, the device user must then disconnect the charging cable from the device and wall socket and place it back into its storage space.

### SUMMARY OF THE INVENTION

The present invention seeks to provide a solution to this problem by providing mobile device users with a mobile device holster that can be converted into an elevated charging device when inserted into an AC wall socket.

### BRIEF DESCRIPTION OF THE DRAWINGS

FIG. 1 Displays the front view of the holster

FIG. 2 Displays the rear view of the holster while its belt clip sits in its open-circuit position

FIG. 3 Displays the rear view of the holster while its belt clip sits in its closed-circuit position

FIG. 4 Displays the side view of the prong housing

FIG. 5 Displays the top view of the belt clip

FIG. 6 Displays the side view of the belt clip

FIG. 7 Displays the side view of the holster and its wireless charging bases' electrical connectors

FIG. 8 Displays the side view of the wireless charging base and its electrical connectors

### DETAILED DESCRIPTION OF THE INVENTION

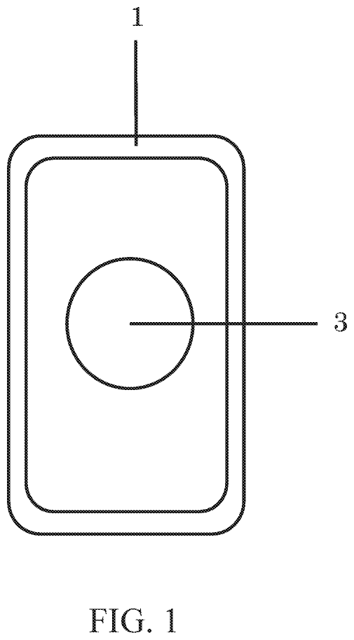

FIG. 1 Displays the front view of the holster (1), in which the interior of the holster contains a wireless charging base (3). The holster is designed to hold a mobile device, allowing the battery of a mobile device to align with the wireless charging base.

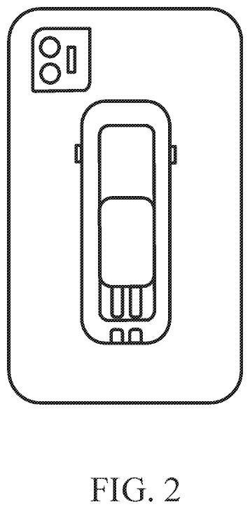

FIG. 2 Displays the rear view of the holster and its belt clip. The belt clip is sitting perpendicular to the base of the holster, creating an open circuit.

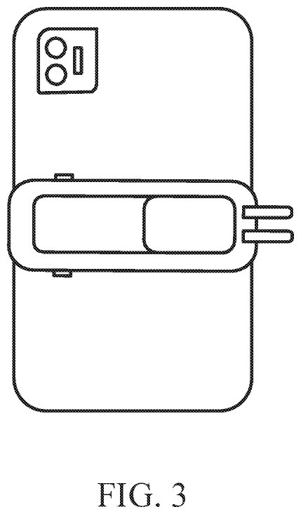

FIG. 3 Displays the rear view of the holster and its belt clip. The belt clip rotated to the left 90 degrees and is sitting parallel to the base of the holster, creating a closed circuit.

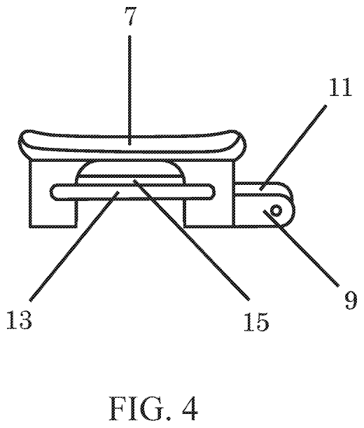

FIG. 4 Displays the side view of the prong housing (7), its prongs (9) and (11) and its conductive railings (13) and (15). The prongs are connected to the conductive railings in which AC voltage is received and transferred.

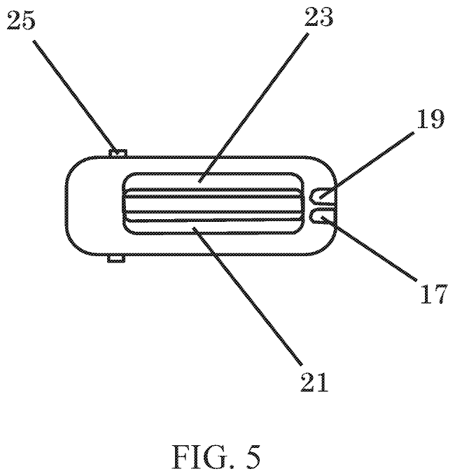

FIG. 5 Displays the top view of the upper portion of the belt clip and its two conductive slots (21) and (23). A conductive slot sits on each side of the upper portion of the belt clip's interior and is used to receive and transfer AC voltage. A conductive pin (25) joins the upper and lower portion of the belt clip and is used to received and transfer AC voltage.

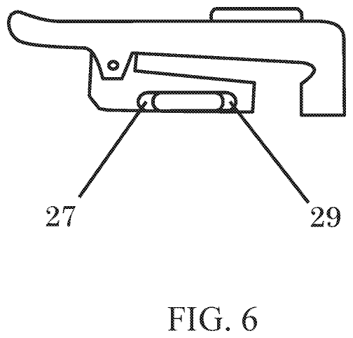

FIG. 6 Displays the side view of the belt clip. The lower portion of the belt clip contains a cylindrical cavity with conductive connectors (27) and (29) in which AC voltage is received and transferred.

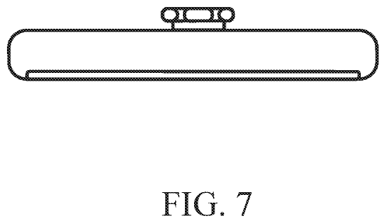

FIG. 7 Displays the side view of the holster and its wireless bases' electrical connectors

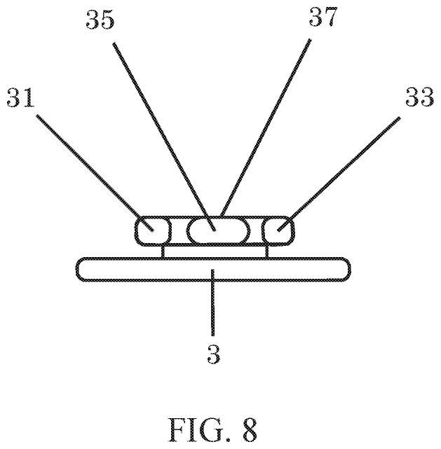

FIG. 8 Displays the side view of the wireless charging pad (3), its insulative connectors (31) and (33) and its conductive connectors (35) and (37). The conductive connectors are used to receive and transfer AC voltage.

1: A holster, comprising;
a wireless charging base
whereby the said wireless charging base charges the battery of an electronic device

2: The wireless charging base of claim 1, comprising;
a cylindrical tube
a cylindrical rotator
whereby the said cylindrical tube sits between the wireless charging base and the base of the cylindrical rotator

3: The cylindrical tube of claim 2
whereby the said cylindrical tube allows for conductive material to be carried into the wireless charging base

4: The cylindrical rotator of claim 2, comprising;
insulative connectors
conductive connectors
whereby the said cylindrical rotator allows the belt clip to rotate

5: The insulative connectors of claim 4
whereby the said insulative connectors stops the flow of electricity

6: The conductive connectors of claim 4
whereby the said conductive connectors receives and transports AC current to the wireless charging base

7: A belt clip, comprising;
a prong housing
a prong opening
a conductive slot
a pin
a base
whereby the said belt clip serves as an electronic transport system in which it receives and transports AC current

8: The prong housing of claim 7, comprising;
conductive prongs
conductive railings
whereby the said conductive prongs are used to receive and transport AC current

9: The conductive railings of claim 8
whereby the said conductive railings are used to transport the prong housing back and forth along the conductive slot of claim 7

10: The conductive railings of claim 8, comprising;
conductive material
whereby the said conductive material is used to receive and transport AC current

11: The prong openings of claim 7, comprising;
two openings on the end of the belt clip
whereby the said prong openings allow prongs to protrude out the end of the belt clip and into an AC wall socket

12: The conductive slot of claim 7, comprising;
conductive material
whereby the said conductive material is used to receive and transport AC current

13: The pin of claim 7, comprising;
Conductive connectors
Whereby the said pin conjoins the belt clip and its base allowing the front end of the belt clip to be lifted and clipped onto a person's waist belt

14: The conductive connectors of claim 13, comprising;
Conductive material
whereby the said conductive material is used to receive and transfer AC current.

15: The base of claim 7, comprising;
a cylindrical cavity
conductive connectors
whereby the said cylindrical cavity rotates around the cylindrical rotator of claim 2

16: The conductive connector of claim 15, comprising;
Conductive material
Whereby the said conductive connectors receive and transport AC current
